(19) United States
(12) Patent Application Publication
(10) Pub. No.: US 2020/0058079 A1
(43) Pub. Date: Feb. 20, 2020

(54) SYSTEMS AND METHODS FOR USING MACHINE LEARNING AND SIMULATIONS FOR INTELLIGENT BUDGETING

(71) Applicant: MASTERCARD INTERNATIONAL INCORPORATED, Purchase, NY (US)

(72) Inventors: Adam Kenneth Hosp, Lake St. Louis, MO (US); Ted P. Sanders, Chesterfield, MO (US); Ellen Christine Walz, St. Louis, MO (US); Andrew J. Smith, St. Louis, MO (US); Stephen Bongner, Dardenne Prairie, MO (US)

(21) Appl. No.: 16/103,768

(22) Filed: Aug. 14, 2018

(51) Int. Cl. G06Q 40/00; G06N 99/00

(52) U.S. Cl. CPC G06Q 40/128; G06N 99/005

(57) ABSTRACT

A simulation and optimization (SO) computing device is configured to receive a request for an intelligent budget, and retrieve historical data for purchase transactions initiated over a period of time. The SO computing device is also configured to assign each purchase transaction one budget class, generate a historical budget model based upon the purchase transactions and budget classes, the historical budget model representing historical spending behavior over the period of time, and execute future budget simulations based upon the historical budget model, each future budget simulation identifying a possible future spending behavior of the user. The SO computing device is further configured to generate intelligent budgets based upon the future budget simulations, wherein each intelligent budget is generated based upon a respective possible future spending behavior that satisfies at least one user-defined budget constraint, cause the intelligent budgets to be displayed, and receive a selection of a user-selected intelligent budget.

### BACKGROUND

The disclosed subject matter relates to machine learning and, more particularly, to a simulation and optimization computing device that leverages simulations, historical data, and machine learning to develop optimized intelligent budgets, customized to an individual.

Many consumers create budgets for themselves in an effort to control and track their spending, build up savings, save money for a large purchase or vacation, or to achieve some other goal. In an effort to assist consumers with budgeting, many software programs and other tools have been developed that consumers can use. Some of these known programs require the consumer to enter their own transaction data and/or set their own budget categories, increasing the time and effort required to maintain the budget and introducing subjectivity. For consumers who may be overspending or using their money inefficiently, such programs may cause the consumer to continue their overspending without the knowledge that there may be better budgeting practices. Moreover, it can be unclear to a consumer where their spending habits can be changed in order to meet their personal spending or savings goals.

Thus, there is a need for a technical solution to assist consumers in the creation of an ultra-personalized budget generated using the consumer's own spending habits and that can be changed or updated as real-time spending habits change to ensure overall compliance.

### BRIEF DESCRIPTION

In one aspect, a simulation and optimization (SO) computing device for generating intelligent budgets is provided. The SO computing device includes one or more processors in communication with one or more memory devices. The SO computing device is configured to receive a request for an intelligent budget from a user operating a user computing device, wherein the request includes at least one user-defined budget constraint, and retrieve, from a first database, historical data associated with a plurality of historical purchase transactions initiated by the user over a period of time. The SO computing device is also configured to assign each historical purchase transaction of the plurality of historical purchase transactions one budget class of a plurality of budget classes, and generate a historical budget model based upon the plurality of historical purchase transactions and the plurality of budget classes, the historical budget model representing historical spending behavior of the user over the period of time. The SO computing device is further configured to execute a plurality of future budget simulations based upon the historical budget model, each future budget simulation of the plurality of future budget simulations identifying a possible future spending behavior of the user, and generate a plurality of intelligent budgets based upon the plurality of future budget simulations, wherein each intelligent budget of the plurality of intelligent budgets is generated based upon a respective possible future spending behavior that satisfies the at least one user-defined budget constraint. In addition, the SO computing device is configured to cause to be displayed, on the user computing device, the plurality of intelligent budgets, and receive, from the user computing device, a selection of a user-selected intelligent budget from the plurality of intelligent budgets.

In another aspect, a computer-implemented method for generating intelligent budgets is provided. The method is implemented using a simulation and optimization (SO) computing device including one or more processors in communication with one or more memory devices. The method includes receiving a request for an intelligent budget from a user operating a user computing device, wherein the request includes at least one user-defined budget constraint, and retrieving, from a first database, historical data associated with a plurality of historical purchase transactions initiated by the user over a period of time. The method also includes assigning each historical purchase transaction of the plurality of historical purchase transactions one budget class of a plurality of budget classes, and generating a historical budget model based upon the plurality of historical purchase transactions and the plurality of budget classes, the historical budget model representing historical spending behavior of the user over the period of time. The method further includes executing a plurality of future budget simulations based upon the historical budget model, each future budget simulation of the plurality of future budget simulations identifying a possible future spending behavior of the user, and generating a plurality of intelligent budgets based upon the plurality of future budget simulations, wherein each intelligent budget of the plurality of intelligent budgets is generated based upon a respective possible future spending behavior that satisfies the at least one user-defined budget constraint. In addition, the method includes causing display, on the user computing device, of the plurality of intelligent budgets, and receiving, from the user computing device, a selection of a user-selected intelligent budget from the plurality of intelligent budgets.

In a further aspect, a non-transitory computer readable storage medium that includes computer executable instructions for generating an intelligent budget is provided. When executed by a simulation and optimization (SO) computing device including a processor in communication with a memory device, the computer executable instructions cause the SO computing device to receive a request for an intelligent budget from a user operating a user computing device, wherein the request includes at least one user-defined budget constraint, and retrieve, from a first database, historical data associated with a plurality of historical purchase transactions initiated by the user over a period of time. The computer executable instructions also cause the SO computing device to assign each historical purchase transaction of the plurality of historical purchase transactions one budget class of a plurality of budget classes, and generate a historical budget model based upon the plurality of historical purchase transactions and the plurality of budget classes, the historical budget model representing historical spending behavior of the user over the period of time. The computer executable instructions further cause the SO computing device to execute a plurality of future budget simulations based upon the historical budget model, each future budget simulation of the plurality of future budget simulations identifying a possible future spending behavior of the user, and generate a plurality of intelligent budgets based upon the plurality of future budget simulations, wherein each intelligent budget of the plurality of intelligent budgets is generated based upon a respective possible future spending behavior that satisfies the at least one user-defined budget constraint. In addition, the computer executable instructions cause the SO computing device to cause to be displayed, on the user computing device, the plurality of intelligent budgets, and receive, from the user computing device, a selection of a user-selected intelligent budget from the plurality of intelligent budgets.

### BRIEF DESCRIPTION OF THE DRAWINGS

FIGS. 1-6 show example embodiments of the methods and systems described herein.

FIG. 1 is a simplified block diagram of an example intelligent budgeting system that includes a simulation and optimization (SO) computing device in accordance with one example embodiment of the present disclosure.

FIG. 2 is an expanded block diagram of the intelligent budgeting system shown in FIG. 1 further illustrating functionality of the SO computing device.

FIG. 3 illustrates one example historical budget model generated and used by the SO computing device shown in FIG. 1.

FIG. 4 illustrates an example configuration of a user computing device that may be used in the intelligent budgeting system shown in FIG. 1.

FIG. 5 illustrates an example configuration of a server system that may be used in the intelligent budgeting system shown in FIG. 1.

FIG. 6 is a flowchart of an example method of using machine learning simulations for intelligent budgeting.

Like numbers in the Figures indicate the same or functionally similar components.

### DETAILED DESCRIPTION

Embodiments of the methods and systems described herein provide a user budgeting platform that provides an interface for collecting information about an individual and causing an intelligent, dynamic budget to be generated and displayed to the individual based on the collected information. In the example embodiment, a simulation and optimization (SO) computing device leverages the collected information and historical data to automatically execute a plurality of simulations and generate a set of intelligent budgets from which the user may choose, as described herein. Active monitoring facilitates incorporation of a user's real-time spending behavior to further refine and optimize the dynamic, intelligent budget.

The “intelligent” budget is so-called because the budget is generated based upon actual user spend behavior in the past and simulated potential user behavior in the future, with respect to a user-defined budget constraint. As such, the budget requires little to no user input to be generated, and may more likely be followed by the user as it reflects user behavior rather than user intent. In addition, the intelligent budget is so-called because it is dynamically monitored and updated to continually reflect, if not influence, real-time user spend with respect to the user-defined budget constraint, as described further herein.

In one example embodiment, an intelligent budgeting system includes a simulation and optimization (SO) computing device. The SO computing device maintains a user budgeting platform, which is accessible to one or more users via their individual user computing device(s). In one embodiment, the user budgeting platform and the functionality of the SO computing device is accessible to the users via a software application (“app”) downloaded and installed on the user computing device. Additionally or alternatively, the user budgeting platform and the functionality of the SO computing device is accessible to the users via a web page accessed using a web browser on the user computing device. The user budgeting platform provides a user interface through which the user can input information to the SO computing device and receive information from the SO computing device, as described further herein.

In the example embodiment, the user inputs a request for an intelligent budget from the SO computing device, via the user budgeting platform. An “intelligent budget,” as used herein, refers to a dynamic budget that is customized and optimized, initially based upon a user's historical spending habits. After the intelligent budget is created, the user's real-time spending behavior is monitored and compared to the intelligent budget. If the user's real-time spending behavior deviates from the intelligent budget, the SO computing device automatically and dynamically provides one or more correction options that can compensate for the deviation. If the user agrees to the correction option, the correction option is incorporated into the intelligent budget, such that the user can stay on track with their spending or savings goals. The SO computing device may provide other functionality, such as alerts or spending freezes, to further assist the user in maintaining financial responsibility, in accordance with the intelligent budget.

The user budgeting platform prompts the user to enter at least one user-defined budget constraint. The user-defined budget constraint may include, for example, a savings goal (e.g., saving $1,000), a maximum spend amount (e.g., spending no more than $1,000 on non-fixed expenses), and/or any other such constraint. The user-defined budget constraint may include additional and/or alternative values or terms. For instance, the user-defined budget constraint may be a particular number of months that the user wishes to limit a savings goal to (e.g., saving $1,000 in five months). In some embodiments, more than one user-defined budget constraint may be entered. For instance, a user may input a $1,000 savings goal as well as a $200 maximum spend in one or more budget classes (e.g., dining). In some such embodiments, the user may be prompted to rank or prioritize the budget constraints.

It is contemplated that some users may be interested in budgeting their finances without a specific goal or budget constraint in mind. For example, a user may want to have a better understanding of their spending habits, but may not have a specific desire to save a particular amount or limit any spending. In such cases, the SO computing device (via the user budgeting platform) may permit a “default” user-defined budget constraint to be selected. This “default” budget constraint may indicate to the SO computing device, in generating intelligent budget options for this user, that an intelligent budget most similar to a historical spending behavior is to be prioritized. In this way, the user may still gain insight into their historical spending behaviors, which will be reflected in the target budget, but may still have the option to select an intelligent budget that facilitates increased savings or improved financial understanding and responsibility.

In some embodiments, the user budgeting platform may prompt the user to enter additional information, which may be optional (i.e., may not be required to request the intelligent budget and advance in the process described herein). The user may enter demographic information (e.g., age), location information (e.g., state, city, ZIP code, etc.), and/or other information. For instance, the user budgeting platform may present the user with one or more survey-style questions to prompt qualitative self-assessment of the user's spending behavior and/or budget constraint, such as “How frugal do you consider yourself to be?”, “How important is this budget constraint to you?”, “Do you wish to impose spending limits to help you stick to your budget?”, etc. The user's answers to such questions may facilitate the SO computing device generating one or more intelligent budgets that suit the specific user's immediate needs. For example, a first user may be more driven to satisfy a budget constraint that includes a savings goal, due to a deadline. This first user may then respond to the survey-style questions with answers that indicate the user is willing to stick to an aggressive budget to meet the savings goal. The SO computing device may then generate and/or prioritize intelligent budgets that meet the savings goal in the shortest period of time but that also institute the biggest spending cuts. A second user may be less interested in drastic changes to their current spending behavior to meet a user-defined budget constraint. This second user may respond to the survey-style questions with answers that indicate the user is not interested in aggressive spending cuts or does not have a strict deadline for meeting the user-defined budget constraint. The SO computing device may then generate and/or prioritize intelligent budgets that reflect the user's historical spending behavior with only minor spending cuts, or with recommendations (described further herein) about where cuts can be made without imposing such cuts.

The user may additionally or alternatively have an option to indicate future events that should be taken into account and/or that may cause a change or deviation from the user's historical trend. For example, the user may have an option to indicate to the SO computing device that the user is moving and will spend more or less on a housing cost, or that the user has cancelled one or more subscriptions and accordingly will be spending less in a corresponding budget class. These examples are illustrative only and are not intended to limit the options the user may have of entering information that may be used by the SO computing device to generate a historical budget model and/or to generate an intelligent budget. Moreover, it should be understood that the SO computing device may include functionality to infer information about a user and/or the user's spend without receiving or requesting such information from the user, and may incorporate inferred and/or received information into the generation of the historical budget model and/or the intelligent budget.

The SO computing device is configured to retrieve or access historical data associated with a plurality of historical purchase transactions initiated by the user over a period of time. In one example embodiment, the user budgeting platform is integrated into and/or otherwise communicatively coupled to an issuer platform (e.g., a mobile banking app also available on the user computing device). The issuer provides one or more payment devices to the user, such as a credit/debit card, a payment token associated with the user computing device, a payment account, etc. The user may provide permission to integrate the user budgeting platform or app with the issuer platform or app, thereby facilitating access for the SO computing device to historical data associated with historical purchase transactions initiated using the payment device. In other embodiments, the user provides information associated with the payment device (e.g., a PAN) directly to the user budgeting platform and provides permission for the SO computing device to access the historical data. In some such embodiments, the SO computing device does not store the payment device information but instead forwards the payment device information to the issuer of the payment device, such that a link between the SO computing device and the issuer may be formed. The SO computing device may then be granted the permission to access the historical data (and/or real-time spending data, as described further herein) until permission is revoked and/or the payment device is disabled.

The SO computing device may retrieve and store (e.g., download) the historical data or a record thereof for further processing and/or may process the historical data upon initial access and store only metadata associated with each historical transaction (e.g., transaction date, amount, merchant identifier, etc.). The SO computing device may access, process, and/or store historical data associated with a particular period of time, such as a year or a number of months before the date of request. In some cases, the SO computing device may access, process, and/or store historical data for all purchase transactions ever initiated using the payment device. In any case, the SO computing device accesses and stores enough data such that the SO computing device may identify aspects of each transaction to develop a historical budget model representing historical spending behavior of the user over the period of time.

In one embodiment, the SO computing device assigns each historical purchase transaction one budget class of a plurality of budget classes. “Budget classes,” as user herein, refer generally to spending categories or types of purchase transactions conducted. Some example budget classes may include “dining,” “recreation,” “health/wellness,” “groceries,” “home costs,” “transportation/travel,” etc. Budget classes may be broader (e.g., “fixed” vs. “variable”) or narrower (e.g., “fast food,” “eat-in restaurant,” “snacks,” etc., may all be sub-classes of “dining”). In some embodiments, the user may be able to request the degree of specificity of the budget classes. In other embodiments, the degree of specificity may be fixed or pre-programmed at the SO computing device or may be automatically selected by the SO computing device based upon a level of variety of the historical purchase transactions. For example, if the user's historical spending behavior (as indicated by the historical purchase transactions in the historical data) shows a high level of variety, the budget classes may be narrower or more specific. In contrast, if the if the user's historical spending behavior (as indicated by the historical purchase transactions in the historical data) shows a low level of variety, the budget classes may be broader or less specific.

In the example embodiment, the SO computing device generates the historical budget model based upon the plurality of historical purchase transactions and the plurality of budget classes. Specifically, the SO computing device implements one or more machine learning processes on the historical data to determine the user's historical spending behavior in each of the budget classes to generate the historical budget model. The SO computing device may identify a level of flexibility (or, in contrast, rigidity) or variability of the user's historical spend in each budget class. In particular, in some embodiments, the SO computing device may be further configured to determine (e.g., calculate) and assign a probability distribution to each budget class, wherein each probability distribution indicates a probability of the user spending a particular amount (e.g., a median amount, an average amount, etc.) within a range of amounts on purchase transactions assigned to each respective budget class. This probability distribution reflects the inherent variability of the user's actual historical spending behavior in each budget class. For example, if a user has consistently spent between $65 and $80 in one budget class each month, the assigned probability distribution is relatively low, and the SO computing device may generate the historical budget model to indicate this low variability of this budget class. For a budget class in which the user has spent $0, $100, $40, $130, $12, and $72, for example, over the past six months, the SO computing device may assign a relatively larger probability distribution about the particular amount (e.g., the median or average amount), which indicates a high level of variability in the amount spent in that budget class.

Additionally or alternatively, in some embodiments, the SO computing device incorporates additional information into generating the historical budget model. Incorporating additional information may be useful in such instances where historical data for the user is only available for a limited period of time (e.g., for a newer account). In some cases, the SO computing device factors in user spending behavior of similar users, such as other users within the same demographic group. In such embodiments, the SO computing device may be configured to assign the user to a user demographic group (e.g., based on user input and/or inferences by the SO computing device). The SO computing device may retrieve from one or more databases other historical data (“demographic historical data”) associated with other individuals in the user demographic group (where the individuals may or may not use the user budgeting platform). The SO computing device may aggregate the demographic historical data to generate a “demographically representative transaction history” for all, most, and/or the average or median individual in that demographic group. The SO computing device may perform the same processes described above with respect to the individual user's historical transaction data in order to use the demographically representative transaction history in the historical budget model for the user. For example, the SO computing device may assign transactions (aggregated, average, median, or individual) to budget classes. The SO computing device may then incorporate those transactions into the historical budget model. Additionally or alternatively, the SO computing device may generate a separate demographic group budget model, with associated probability distributions for respective budget classes, that is representative only of the demographic group and not specific to the user. As described further herein, the SO computing device may use this demographic group budget model to execute simulations, generate correction options, generate recommendations, etc.

Optionally, in some embodiments, the user may be provided with an opportunity to view and/or edit the historical data that is used to generate the historical budget model. The user may have options to, for example, limit the period of time, exclude certain purchases (e.g., exclude purchases from a “splurge” vacation that do not reflect typical spending behavior), or exclude an entire budget class from further processing. Additionally or alternatively, the user may have options to indicate features of certain budget classes, such as a level of flexibility (or, in contrast, rigidity) of certain budget classes (e.g., if the user disagrees with the automatic determination of those features by the SO computing device).

The SO computing device is configured to execute a plurality of future budget simulations based upon the historical budget model. Each future budget simulation identifies a possible or potential future spending behavior of the user. Each future budget simulation may be automatically associated with a likelihood that the outcome of that budget simulation will occur, for example, based upon the historical budget model (e.g., the probability distributions). The future budget simulations may be executed for a pre-defined future period of time, such as a possible future month, two months, six months, year, etc. The future period of time may be a default period of time or may be defined by the SO computing device prior to executing the simulations based upon the period of time for which the historical data was available or accessed. For instance, if only two months of historical data were accessed, the future period of time may be only one month. As another example, if three years of historical data were access, the future period of time may be six months, or eight months. Additionally or alternatively, the future period of time may be pre-defined based upon the initial user input to the SO computing device. For example, if the user wants to meet a savings goal within eight months, the future period of time may be equal to or about eight months (e.g., between seven to nine months). In one particular embodiment, the SO computing device executes the future budget simulations as Monte Carlo simulations, using the assigned probability distributions for each budget class of the plurality of budget classes. In other words, each simulation is performed as a Monte Carlo iteration. In other embodiments, the SO computing device executes the future budget simulations using any computer-based simulation modeling, such as, but not limited to, stochastic modeling, numerical modeling, statistical modeling, multimethod modeling, etc.

The SO computing device may be configured to record an outcome of each future budget simulation. The outcome may include how much was spent in each budget class over the future period of time and/or over portions of the future of time (e.g., each month within a future period of time defined as six months). The outcome may, additionally or alternatively, include overall spend and/or overall savings. The outcome may, additionally or alternatively, include possible future spending trends, such as a steady decrease or increase in one or more of the budget classes.

In various embodiments, the SO computing device executes any number of future budget simulations, such as from five to thousands of simulations. In the example embodiment, the SO computing device includes processing and data storage capabilities such that the SO computing device can execute hundreds to thousands of future budget simulations. As the number of future budget simulations increases, the precision of available and/or likely outcomes may increase. Put another way, the SO computing device may be more able to accurately predict what is more likely to occur for the user and may thereby generate intelligent budgets that the user is more likely to follow, increasing the likelihood of the user meeting their financial goals.

The SO computing device may then compare the outcome of a future budget simulation to the user-defined budget constraint (which may be described as comparing the future budget simulation to the user-defined budget constraint). The SO computing device may identify those future budget simulations that, if they were to occur, would satisfy the user-defined budget constraint and those future budget simulations that, in contrast, would not satisfy the user-defined budget constraint. To “satisfy” the user-defined budget constraint, the outcome of the future budget simulation may or may not exactly meet the user-defined budget constraint. “Satisfying” the user-defined budget constraint may include not only meeting or exceeding (in the sense of advancing past a goal) the user-defined budget constraint, but also may include those future budget simulations with an outcome that falls within a range of the user-defined budget constraint. For example, a future budget simulation in which a user meets 90% of a savings goal or spends only up to 105% of a maximum spend amount may be considered to satisfy the user-defined budget constraint. In some embodiments, the SO computing device may define a threshold of satisfaction based upon user input. For example, where a user has indicated that the budget constraint is very important, the threshold of satisfaction may be very small (e.g., within or below 1%), whereas if the user indicated the budget constraint is less important, the threshold of satisfaction may be larger (e.g., within 10%). In some embodiments, additionally or alternatively, the SO computing device may automatically define a threshold of satisfaction based upon inferences about a user and/or based upon average or default thresholds of satisfaction. The SO computing device may be configured to isolate the future budget simulations having outcomes that satisfy the user-defined budget constraint from those that do not.

In some embodiments, the SO computing device executes the plurality of future budget simulations based upon portions of the historical budget model. For instance, simulating variability in a budget class where the historical spending is substantially fixed may increase the required processing and/or data storage capability of the SO computing device. In some such cases, it would be beneficial to exclude portions of the historical budget model from simulations that are not likely to vary, thereby decreasing a number of variables in each simulation. In some embodiments, the SO computing device is configured to determine, based on the historical data, that an amount spent by the user in a first budget class of the plurality of budget classes is substantially fixed. The SO computing device may flag the first budget class as a fixed budget class, and may exclude the fixed budget class (and/or any other fixed budget class(es)) from varying in the plurality of future budget simulations. Additionally or alternatively, the SO computing device may exclude the fixed budget class(es) from the future budget simulations entirely.

The SO computing device is further configured to generate a plurality of intelligent budgets based upon the plurality of future budget simulations. Each intelligent budget is generated based upon a respective possible future spending behavior (of a respective one or more future budget simulation) that satisfies the at least one user defined budget constraint. Put another way, each intelligent budget is generated based upon the outcome of one or more future budget simulations satisfying the at least one user-defined budget constraint.

In one particular embodiment, the SO computing device is configured to identify a plurality of subsets of the outcomes that satisfy the user-defined budget constraint, each subset including outcomes having one or more common factors. For instance, the SO computing device groups or aggregates a plurality of future budget simulations that all include a trending decrease in spending in budget class A into a first subset. The SO computing device groups or aggregates a different plurality of future budget simulations that all include a paired decrease in spending in budget classes B and C, and an increased spend in a budget class D within a particular range, into a second subset. These are merely examples of the ways that the SO computing device groups like future budget simulations and should not be considered to limit the available functionality of the SO computing device. The SO computing device may then generate a corresponding intelligent budget that includes the one or more common factors of each subset. Continuing with the above examples, the SO computing device may generate a first intelligent budget based on the first subset (that includes a trending decrease in budget class A) and a second intelligent budget based on the second subset (that includes a paired decrease in spending in budget classes B and C and that permits an increased spend in budget class C within the particular range).

In some embodiments, the SO computing device may incorporate the demographic group budget model into the future budget simulations (e.g., as one or more additional variables and/or to widen or otherwise adjust probability distributions). Additionally or alternatively, the SO computing device may compare the user's historic budget model to the demographic group budget model to identify an outlying user budget class where the user exceeds (e.g., by a threshold amount) a demographic spend in that budget class. The SO computing device may include a recommendation, alert, message, or other indication of this outlying user budget class in one or more of the intelligent budgets to be presented to the user. For instance, one or more of the intelligent budgets may include a (proposed) decreased spend in the outlying user budget class with a message to the user that the user is over-spending in this budget class, compared to similar individuals. In this way, the SO computing device may alert the user to what could be a possible reduction in spend even if the user over-spends in that budget class, by letting the user know that other individuals spend less (i.e., letting the user know that it's “possible” to spend less in that budget class).

Some of the plurality of intelligent budgets may include common features, such as a limit on spending in one or more of the same budget classes. However, each intelligent budget is unique from the others and, therefore, presents a different route to satisfying the user-defined budget constraint. The intelligent budgets may include descriptions or other message of the particular ways in which that budget helps the user meet their budget constraint. For instance, one budget may include a message to the user that indicates a decrease in a “coffee” budget class of 20% (e.g., cutting out a coffee purchase once during a workweek) would help the user meet their spending goals.

The SO computing device is configured to cause to be displayed the set of intelligent budgets on the user's computing device (e.g., within the budgeting app of the user budgeting platform). The SO computing device may permit the user to see various features of each intelligent budget, such as an outcome of following the intelligent budget over a period of time. For example, the SO computing device may cause the display to the user of the outcome (e.g., spend and/or savings) of following one intelligent budget over six months, or over each month of the six months (e.g., using a slider or via a graph). The display may enable to the user to see a detailed breakdown of the intelligent budget by time, by budget class, by total outcome, by trending outcome, a level of satisfaction of the user-defined budget constraint, and/or any other details of the intelligent budget. The display may further enable the user to rank or sort the intelligent budgets by any of these features. For instance, the user may be able to select an option that sorts the intelligent budgets based on how fast a savings goal is met, or based on the least decrease in spend in one budget class. The display may also enable a user to grade or otherwise indicate their satisfaction with a particular intelligent budget (e.g., a “thumbs up” or “thumbs down”). The SO computing device may record and process the user's interactions with the displayed intelligent budget to determine whether there are commonalities to intelligent budgets of which the user approves or disapproves. For example, if the user consistently disapproves of intelligent budgets that suggest reducing an entertainment budget, the SO computing device may exclude or remove other budgets that include that feature. The SO computing device may additionally or alternatively prevent a reduction in an entertainment budget class from being suggested in the future.

Accordingly, the SO computing device enables interaction with each intelligent budget such that the user may select the particular intelligent budget that best suits the user's needs and/or wishes. The SO computing device receives, from the user computing device, a selection of a user-selected intelligent budget from the set of intelligent budgets. The user-selected intelligent budget forms the basis for active monitoring of the user's real-time or current spending behavior.

In the example embodiment, the SO computing device monitors the real-time spending behavior of the user based upon a plurality of purchase transactions initiated by the user after selection of the user-selected intelligent budget. The real-time spending behavior is automatically compared to the intelligent budget. As the intelligent budget was generated based upon possible, potential, or theoretical behavior of the user, there may be differences between the user's actual real-time spending behavior and the user-selected intelligent budget. Some differences may be “positive,” in that those differences increase the likelihood that the user, following the budget and making real-time spending decisions, will meet their budget constraint. Other differences may be “negative,” in that those differences decrease the likelihood that the user, following the budget and making real-time spending decisions, will meet their budget constraint. These “negative” differences may be referred to as “deviations,” and are generally characterized by the user over-spending in one or more budget classes and/or over-spending overall. The SO computing device may be configured to detect (e.g., in real-time or without substantial delay between deviating behavior and detection) that the real-time spending behavior of the user deviates from the user-selected intelligent budget by a deviation factor. The SO computing device, in response, may generate one or more correction options to compensate for the deviation from the user-selected intelligent budget. Put another way, the correction option(s) are generated to put the user “back on track” with respect to the budget and/or the budget constraint.

In some embodiments, the correction options may be generated as reductions in future spending in the same budget classes in which the over-spending occurred. In other embodiments, the correction options may be generated based upon the demographic group budget model and/or correction options generated for other individuals in the same demographic group. For instance, if the SO computing device identifies an outlying user budget class for the user, the SO computing device may generate a correction option including a reduction in spend in the outlying user budget class, with or without a message indicating to the user that the user over-spends in the outlying user budget class compared to other individuals in the demographic group. In other embodiments, the correction options may be generated dynamically, based on the real-time spending behavior of the user (after the selection of the user-selected intelligent budget) and the historical budget model. Specifically, in some embodiments, the SO computing device is configured to execute a plurality of budget correction simulations based upon the historical budget model, the real-time spending behavior, and the deviation factor. In other words, the SO computing device factors in the spending the user has performed since the initial generation and selection of the budget, and executes new future budget simulations, referred to here as “budget correction simulations.” The SO computing device may then generate the one or more correction options based upon the budget correction simulations. Each correction option corrects the deviation factor such that a combination of the user-selected intelligent budget, the real-time spending behavior, and the respective correction option satisfies the at least one user defined budget constraint.

The SO computing device presents the correction options to the user in much the same way as the intelligent budgets are presented. The user may explore details of the correction options and select one or more of the correction options to incorporate into the intelligent budget. The SO computing device incorporates any selected options into the intelligent budget and continues real-time monitoring of user spending behavior as described above. The monitoring and correcting process can be implemented any number of times. In some cases, the user may choose not to incorporate any correction options, and the intelligent budget is maintained as initially selected.

The user can select how the user wants the SO computing device to handle deviations. The user may choose to receive and implement correction options, as described above. The user may additionally or alternatively request alerts from the SO computing device. The SO computing device, in accordance with user preferences, may generate and transmit alerts to the user's computing device when the user overspends in any budget class. The user may have preferences for when the alerts are to be generated, such as only when the user overspends by a threshold amount, when the user is about to overspend (e.g., is within a threshold range of a maximum spend of the budget class), and/or under any other conditions. The alerts may cause various outcomes, in accordance with user preferences. The alerts may cause the user computing device to activate to alert the user to the overspending (e.g., as a push notification or other alert message). The alerts may, additionally or alternatively, cause a spending freeze at merchants or on transactions that would fall within a particular budget class that would result in an over-spend in that budget class. In such cases, the SO computing device may communicate with an issuer computing device to implement the spending freeze in that budget class. In some embodiments, the issuer computing device incorporates messaging to the SO computing device into transaction processing, such that the SO computing device performs decisioning about whether or not to allow a transaction and/or whether to transmit an alert during processing of a transaction.

At least one technical problem with known systems is that budgets are determined and followed statically. Put another way, a user defines their budget (or requests that a system present them with a budget) that includes spending limits in certain categories. But once that budget is set, it stays the same until manual changes are made or requested. Although certain known systems may alert users to over-spending in a budget category, these known systems do not factor that over-spending into the future state of the budget or the user's financial goals. These systems fail to provide corrective measures. Moreover, these systems fail to take into account a user's actual (whether historical or real-time) spending habits to develop dynamic, intelligent budgets that are feasible for the user to achieve. As these systems generate static, one-time budgets, these systems fail to react to changing user habits and/or user input (e.g., changing spending goals).

The embodiments described herein address at least these technical problems. Specifically, the SO computing device described herein provides an advancement over known budgeting systems with improved processing and storage capabilities that facilitate executing and storing hundreds or even thousands of simulation iterations, as well as comparing the outcomes of the simulations to a user-defined budget constraint. The SO computing device receives input from a user, mines existing databases for pertinent information, and quickly (e.g., in real-time) executes a plurality of simulations to generate and display a plurality of intelligent budgets that reflect the user's actual behavior and react to real-time spend. More specifically, the SO computing device automatically and dynamically performs additional execution and iteration of the simulations based on real-time spending behaviors (e.g., deviations from the intelligent budget or reduced spending in one or more budget classes) to incorporate corrective solutions or positive rewards into the ongoing intelligent budget to expedite user financial goals.

The methods and systems described herein may be implemented using computer programming or engineering techniques including computer software, firmware, hardware or any combination or subset thereof, wherein the technical effects may be achieved by performing at least one of the following steps: (a) receiving a request for an intelligent budget from a user, wherein the request includes at least one user-defined budget constraint; (b) retrieving, from a first database, historical data associated with a plurality of historical purchase transactions initiated by the user over a period of time; (c) assigning each historical purchase transaction of the plurality of historical purchase transactions one budget class of a plurality of budget classes; (d) generating a historical budget model based upon the plurality of historical purchase transactions and the plurality of budget classes, the historical budget model representing historical spending behavior of the user over the period of time; (e) executing a plurality of future budget simulations based upon the historical budget model, each future budget simulation of the plurality of future budget simulations identifying a possible future spending behavior of the user; (f) generating a plurality of intelligent budgets based upon the plurality of future budget simulations, wherein each intelligent budget of the set of intelligent budgets is generated based upon a respective possible future spending behavior that satisfies the at least one user defined budget constraint; (g) causing display, on a user computing device of the user, of the set of intelligent budgets; and (h) receiving, from the user computing device, a selection of a user-selected intelligent budget from the set of intelligent budgets.

Further, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The system is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in a variety of applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The systems and processes are not limited to the specific embodiments described herein. In addition, components of each system and each process can be practiced independently and separate from other components and processes described herein. Each component and process also can be used in combination with other assembly packages and processes.

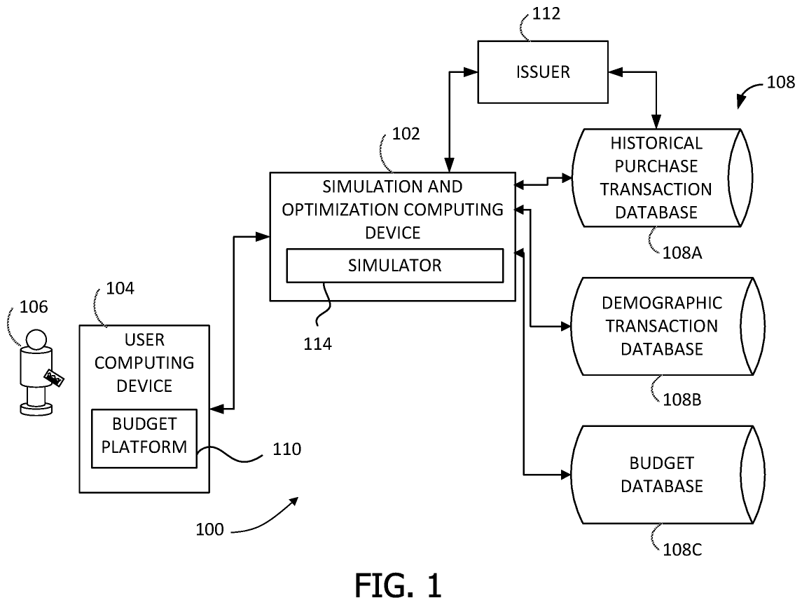

FIG. 1 is a simplified block diagram of one embodiment of an intelligent budgeting system 100 that includes a simulation and optimization (SO) computing device 102. SO computing device 102 is in communication with a user computing device 104 operated by a user 106. SO computing device 102 is further in communication with one or more databases 108, illustrated as a historical purchase transaction database 108A, a demographic transaction database 108B, and a budget database 108C. One or more of the databases 108 may be integral to SO computing device 102. Additionally or alternatively, one or more of databases 108 may be remote from SO computing device 102 and may be non-centralized (e.g., in a cloud computing configuration).

SO computing device 102 may be communicatively coupled with any computing device in intelligent budgeting system 100, such as user computing device(s) 104, through many interfaces including a network, such as a local area network (LAN) and/or a wide area network (WAN), dial-in connections, cable modems, wireless-connections, and special high-speed ISDN lines. In one embodiment, user computing device(s) 104 are computers including a web browser, such that SO computing device 102 is accessible to user computing device(s) 104 using the Internet or another network. User computing device 104 may be any device capable of interconnecting to the Internet including a web-based phone, personal digital assistant (PDA), watch, medical device, kiosk, laptop computer, desktop computer, netbook, tablet, phablet, or other web-connectable equipment. In the example embodiment, SO computing device 102 maintains a user budgeting platform 110, which is accessible to one or more users 106 via their individual user computing device(s) 104. In one embodiment, user budgeting platform 110 and the functionality of SO computing device 102 is accessible to users 106 via a software application (“app”) downloaded and installed on user computing device 104. Additionally or alternatively, user budgeting platform 110 and the functionality of SO computing device 102 is accessible to users 106 via a web page accessed using a web browser on user computing device 104. User budgeting platform 110 provides a user interface through which user 106 can input information to SO computing device 102 and receive information from SO computing device 102.

SO computing device 102, in some embodiments, is in communication with one or more issuer computing devices 112. Issuer computing device 112 is associated with an issuer of a payment device used by user 106 to initiate purchase transactions (e.g., a credit/debit card, payment account, token on user computing device 104, etc.). SO computing device 102 may communicate with issuer computing device 112 to access one or more of databases 108 that are maintained by issuer computing device 112, such as historical purchase transaction database 108A and/or demographic transaction database 108B.

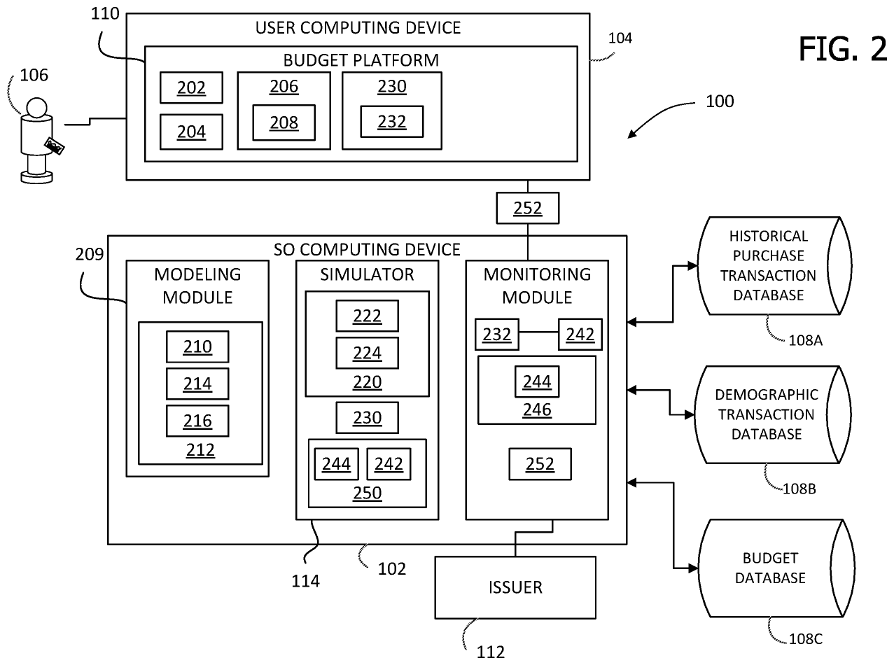

In the example embodiment, SO computing device 102 includes components (e.g., modules executed on one or more processing devices) such that SO computing device 102 functions as described herein. In particular, and as described further herein with respect to FIG. 2, SO computing device 102 includes a simulating component 114 configured to execute a plurality (e.g., hundreds or thousands) of future budget simulations that are used to generate a set of intelligent budgets for user 106.

FIG. 2 is an expanded block diagram of intelligent budgeting system 100 (shown in FIG. 1) further illustrating functionality of SO computing device 102. SO computing device 102 is shown and described as having various modules executed on one or more processing devices thereof. It should be understood that SO computing device 102 may have more, fewer, or alternative modules and/or that the functionality of SO computing device 102 may be otherwise implemented.

In the example embodiment, user 106 inputs a request for an intelligent budget from SO computing device 102, via user budgeting platform 110 (shown in FIG. 1). During the request process, user budgeting platform 110 prompts user 106 to enter at least one user-defined budget constraint 202. User-defined budget constraint 202 may include, for example, a savings goal (e.g., saving $1,000), a maximum spend amount (e.g., spending no more than $1,000 on non-fixed expenses), and/or any other such constraint. User-defined budget constraint 202 may include additional and/or alternative values or terms. For instance, user-defined budget constraint 202 may be a particular number of months that user 106 wishes to limit a savings goal to (e.g., saving $1,000 in five months). In some embodiments, more than one user-defined budget constraint 202 may be entered. For instance, user 106 may input a $1,000 savings goal as well as a $200 maximum spend in one or more budget classes (e.g., dining). In some such embodiments, user 106 may be prompted to rank or prioritize budget constraints 202. It is contemplated that some users 106 may be interested in budgeting their finances without a specific goal or budget constraint 202 in mind. For example, a user 106 may want to have a better understanding of their spending habits, but may not have a specific desire to save a particular amount or limit any spending. In such cases, SO computing device 102 (via user budgeting platform 110) may permit a “default” user-defined budget constraint 202 to be selected or input by user 106. This “default” budget constraint 202 may indicate to SO computing device 102, in generating intelligent budget options for user 106, that an intelligent budget most similar to a historical spending behavior is to be prioritized.

In some embodiments, user budgeting platform 110 may prompt user 106 to enter additional information 204, which may be optional (i.e., may not be required to request the intelligent budget and advance in the process described herein). User 106 may enter demographic information (e.g., age), location information (e.g., state, city, ZIP code, etc.), and/or other information 204. For instance, user budgeting platform 110 may present the user with one or more survey-style questions 206 to prompt qualitative self-assessment of the user's spending behavior and/or budget constraint 202, such as “How frugal do you consider yourself to be?”, “How important is this budget constraint to you?”, “Do you wish to impose spending limits to help you stick to your budget?”, etc. The user's answers to such questions 206 may facilitate SO computing device 102 generating one or more intelligent budgets that suit the specific user's immediate needs. For example, a first user 106 may be more driven to satisfy a budget constraint 202 that includes a savings goal, due to a deadline. This first user 106 may then respond to survey-style questions 206 with answers 208 that indicate the first user 106 is willing to stick to an aggressive budget to meet the savings goal. SO computing device 102 may then generate and/or prioritize intelligent budgets that meet the savings goal in the shortest period of time but that also institute the biggest spending cuts. A second user 106 may be less interested in drastic changes to their current spending behavior to meet a user-defined budget constraint 202. This second user 106 may respond to survey-style questions 206 with answers 208 that indicate the second user 106 is not interested in aggressive spending cuts or does not have a strict deadline for meeting user-defined budget constraint 202. SO computing device 102 may then generate and/or prioritize intelligent budgets that reflect the user's historical spending behavior with only minor spending cuts, or with recommendations about where cuts can be made without imposing such cuts.

User 106 may additionally or alternatively have an option to indicate future events that should be taken into account and/or that may cause a change or deviation from the user's historical spend. For example, user 106 may have an option to indicate to SO computing device 102 that user 106 is moving and will spend more or less on a housing cost, or that user 106 has cancelled one or more subscriptions and accordingly will be spending less in a corresponding budget class.

SO computing device 102 is configured to retrieve or access historical data 210 associated with a plurality of historical purchase transactions initiated by user 106 over a period of time, from historical purchase transaction database 108A. In one example embodiment, user budgeting platform 110 is integrated into and/or otherwise communicatively coupled to an issuer platform (e.g., a mobile banking app also available on user computing device 104) maintained by issuer computing device 112 (shown in FIG. 1). User 106 may provide permission to integrate user budgeting platform 110 with the issuer platform or app, thereby facilitating access for SO computing device 102 to historical data 210 from historical purchase transaction database 108A. In other embodiments, user 106 provides information associated with their payment device directly to user budgeting platform 110 and provides permission for SO computing device 102 to access historical data 210.

SO computing device 102 may retrieve and store (e.g., download, such as to budget database 108C or any other memory) historical data 210 or a record thereof for further processing and/or may process historical data 210 upon initial access and store only metadata associated with each historical transaction (e.g., transaction date, amount, merchant identifier, etc.). SO computing device 102 may access, process, and/or store historical data 210 associated with a particular period of time, such as a year or a number of months before the date of request. In some cases, SO computing device 102 may access, process, and/or store historical data 210 for all purchase transactions ever initiated using the payment device. In any case, SO computing device 102 accesses and stores enough data such that SO computing device 102 may identify aspects of each transaction to develop a historical budget model 212 representing historical spending behavior of user 106 over the period of time. In one embodiment, SO computing device 102 assigns each historical purchase transaction in historical data 210 one budget class of a plurality of budget classes.

In the example embodiment, SO computing device 102 (specifically, a modeling module 209 thereof) generates historical budget model 212 based upon the plurality of historical purchase transactions of historical data 210 and the plurality of budget classes. Specifically, SO computing device 102 device implements one or more machine learning processes on historical data 210 to determine the user's historical spending behavior in each of the budget classes to generate historical budget model 212. SO computing device 102 may identify a level of flexibility (or, in contrast, rigidity) or variability of the user's historical spend in each budget class. In particular, in some embodiments, SO computing device 102 may be further configured to determine (e.g., calculate) and assign a probability distribution 214 to each budget class, wherein each probability distribution 214 indicates a probability of user 106 spending a particular amount (e.g., a median amount, an average amount, etc.) within a range of amounts on purchase transactions assigned to each respective budget class. Probability distributions 214 reflect the inherent variability of the user's actual historical spending behavior in each budget class. For example, if user 106 has consistently spent between $65 and $80 in one budget class each month, the assigned probability distribution 214 is relatively low, and SO computing device 102 may generate historical budget model 212 to indicate this low variability of this budget class. For a budget class in which user 106 has spent $0, $100, $40, $130, $12, and $72, for example, over the past six months, SO computing device 102 may assign a relatively larger probability distribution 214 about the particular amount (e.g., the median or average amount), which indicates a high level of variability in the amount spent in that budget class.

Additionally or alternatively, in some embodiments, SO computing device 102 incorporates additional information 216 (which may include additional information 204) into generating historical budget model 212. Incorporating additional information 216 may be useful in such instances where historical data 210 for user 106 is only available for a limited period of time (e.g., for a newer account). In some cases, SO computing device 102 factors in user spending behavior of similar users, such as other users within the same demographic group. In such embodiments, SO computing device 102 may be configured to assign user 106 to a user demographic group. SO computing device 102 may retrieve from demographic transaction database 108B other historical data (“demographic historical data,” not specifically shown) associated with other individuals in the user demographic group (where the individuals may or may not use user budgeting platform 110). SO computing device 102 may aggregate the demographic historical data to generate a “demographically representative transaction history” for all, most, and/or the average or median individual in that demographic group. SO computing device 102 may perform the same processes described above with respect to the individual user's historical data 210 in order to use the demographically representative transaction history in historical budget model 212 for user 106. For example, SO computing device 102 may assign transactions (aggregated, average, median, or individual) to budget classes. SO computing device 102 may then incorporate those transactions into historical budget model 212. Additionally or alternatively, SO computing device 102 may generate a separate demographic group budget model (not specifically shown), with associated probability distributions 214 for respective budget classes, that is representative only of the demographic group and not specific to user 106. As described further herein, SO computing device 102 may use this demographic group budget model to execute simulations, generate corrections options, generate recommendations, etc.

Optionally, in some embodiments, user 106 may be provided with an opportunity to view and/or edit historical data 210 that is used to generate historical budget model 212. User 106 may have options to, for example, limit the period of time, exclude certain purchases (e.g., exclude purchases from a “splurge” vacation that do not reflect typical spending behavior), or exclude an entire budget class from further processing. Additionally or alternatively, user 106 may have options to indicate features of certain budget classes, such as a level of flexibility (or, in contrast, rigidity) of certain budget classes (e.g., if the user disagrees with the automatic determination of those features by SO computing device 102).

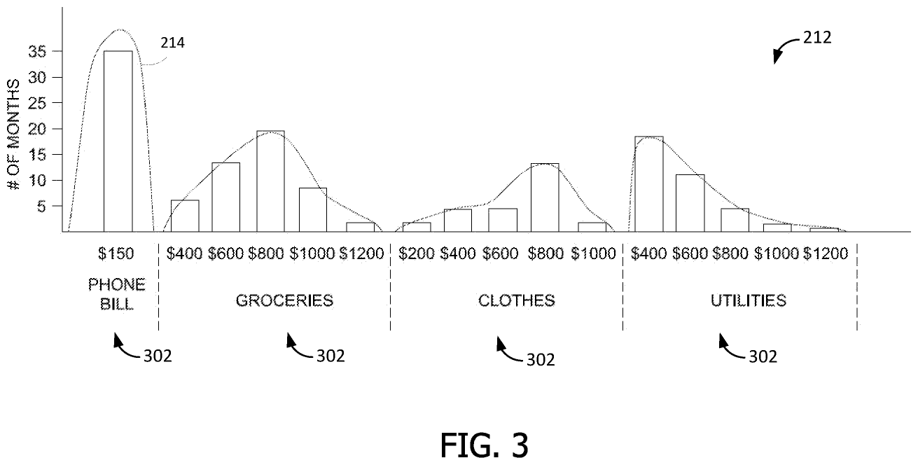

FIG. 3 illustrates one example embodiment of a historical budget model 212. Several budget classes 302 are defined, including phone bill, grocery, clothes, and utilities budget classes 302. A historical spend amount in each budget class, and a frequency of spending each amount, is incorporated into a probability distribution 214 for each budget class 302.

Returning to FIG. 2, SO computing device 102 (specifically, simulator 114 thereof) is configured to execute a plurality of future budget simulations 220 based upon historical budget model 212. Each future budget simulation 220 identifies a possible or potential future spending behavior of user 106 (also referred to as an “outcome” 222). Each future budget simulation 220 may be automatically associated with a likelihood that the outcome 222 of that budget simulation 220 will occur, for example, based upon historical budget model 212 (e.g., probability distributions 214). Future budget simulations 220 may be executed for a pre-defined future period of time 224, such as a possible future month, two months, six months, year, etc. Future period of time 224 may be a default period of time 224 or may be defined by SO computing device 102 prior to executing simulations 220 based upon the period of time for which historical data 210 was available or accessed. Additionally or alternatively, future period of time 224 may be pre-defined based upon the initial user input to SO computing device 102. For example, if user 106 wants to meet a savings goal within eight months, future period of time 224 may be equal to or about eight months (e.g., between seven to nine months). In one particular embodiment, SO computing device 102 executes future budget simulations 220 as Monte Carlo simulations, using the assigned probability distributions 214 for each budget class of the plurality of budget classes. In other embodiments, SO computing device 102 executes future budget simulations 220 using any computer-based simulation modeling, such as, but not limited to, stochastic modeling, numerical modeling, statistical modeling, multimethod modeling, etc.

SO computing device 102 may be configured to record outcome 222 of each future budget simulation 220. Outcome 222 may include how much was spent in each budget class over future period of time 224 and/or over portions of future of time 224 (e.g., each month within a future period of time 224 defined as six months). Outcome 222 may, additionally or alternatively, include overall spend and/or overall savings. Outcome 222 may, additionally or alternatively, include possible future spending trends, such as a steady decrease or increase in one or more of the budget classes.

In various embodiments, SO computing device 102 executes any number of future budget simulations 220, such as from five to thousands of simulations. In the example embodiment, SO computing device 102 includes processing and data storage capabilities such that SO computing device 102 can execute hundreds to thousands of future budget simulations 220. As the number of future budget simulations 220 increases, the precision of available and/or likely outcomes 222 may increase. Put another way, SO computing device 102 may be more able to accurately predict what is more likely to occur for user 106 and may thereby generate intelligent budgets that user 106 is more likely to follow, increasing the likelihood of user 106 meeting their financial goals.

SO computing device 102 may then compare outcome 222 of a future budget simulation 220 to user-defined budget constraint 202 (which may be described as comparing future budget simulation 220 to user-defined budget constraint 202). SO computing device 102 may identify those future budget simulations 220 that, if they were to occur, would satisfy user-defined budget constraint 202 and those future budget simulations 220 that, in contrast, would not satisfy user-defined budget constraint 202. To “satisfy” user-defined budget constraint 202, outcome 222 of future budget simulation 220 may or may not exactly meet user-defined budget constraint 202. “Satisfying” user-defined budget constraint 202 may include not only meeting or exceeding (in the sense of advancing past a goal) user-defined budget constraint 202, but also may include those future budget simulations 220 with an outcome 222 that falls within a range of user-defined budget constraint 202. For example, a future budget simulation 220 in which a user meets 90% of a savings goal or spends only up to 105% of a maximum spend amount may be considered to satisfy user-defined budget constraint 202. In some embodiments, SO computing device 102 may define a threshold of satisfaction based upon user input. For example, where user 106 has indicated that budget constraint 202 is very important, the threshold of satisfaction may be very small (e.g., within or below 1%), whereas if user 106 indicated that budget constraint 202 is less important, the threshold of satisfaction may be larger (e.g., within 10%). In some embodiments, additionally or alternatively, SO computing device 102 may automatically define a threshold of satisfaction based upon inferences about user 106 and/or based upon average or default thresholds of satisfaction. SO computing device 102 may be configured to isolate future budget simulations 220 having outcomes that satisfy user-defined budget constraint 202 from those that do not.

In some embodiments, SO computing device 102 executes the plurality of future budget simulations 220 based upon portions of historical budget model 212. For instance, simulating variability in a budget class where the historical spending is substantially fixed may increase the required processing and/or data storage capability of SO computing device 102. In some such cases, it would be beneficial to exclude portions of historical budget model 212 that are not likely to vary from simulations 220, thereby decreasing a number of variables in each simulation 220. In some embodiments, SO computing device 102 is configured to determine, based on historical data 210 and/or historical budget model 212, that an amount spent by user 106 in a first budget class of the plurality of budget classes is substantially fixed. SO computing device 102 may flag the first budget class as a fixed budget class, and may exclude the fixed budget class (and/or any other fixed budget class(es)) from varying in future budget simulations 220. Additionally or alternatively, SO computing device 102 may exclude the fixed budget class(es) from future budget simulations 220 entirely.

SO computing device 102 is configured to generate a plurality of intelligent budgets 230 based upon the plurality of future budget simulations 220. Each intelligent budge 230t is generated based upon a respective possible future spending behavior (of a respective one or more future budget simulation 220) that satisfies user defined budget constraint 202. Put another way, each intelligent budget 230 is generated based upon outcome 222 of one or more future budget simulations 220 satisfying user-defined budget constraint 202.

In one particular embodiment, SO computing device 102 is configured to identify a plurality of subsets of outcomes 222 that satisfy user-defined budget constraint 202, each subset including outcomes 222 having one or more common factors. For instance, SO computing device groups or aggregates a plurality of future budget simulations 220 that all include a trending decrease in spending in budget class A into a first subset. SO computing device 102 groups or aggregates a different plurality of future budget simulations 220 that all include a paired decrease in spending in budget classes B and C, and an increased spend in a budget class D within a particular range, into a second subset. SO computing device 102 may then generate a corresponding intelligent budget 230 that includes the one or more common factors of each subset. Continuing with the above examples, SO computing device 102 may generate a first intelligent budget 230 based on the first subset (that includes a trending decrease in budget class A) and a second intelligent budget 230 based on the second subset (that includes a paired decrease in spending in budget classes B and C and that permits an increased spend in budget class C within the particular range).

In some embodiments, SO computing device 102 may incorporate the demographic group budget model into future budget simulations 220 (e.g., as one or more additional variables and/or to widen or otherwise adjust probability distributions 214). Additionally or alternatively, SO computing device 102 may compare the user's historic budget model 212 to the demographic group budget model to identify an outlying user budget class where user 106 exceeds (e.g., by a threshold amount) a demographic spend in that budget class. SO computing device 102 may include a recommendation, alert, message, or other indication of this outlying user budget class in one or more of intelligent budgets 230 to be presented to user 106. For instance, one or more of the intelligent budgets 230 may include a (proposed) decreased spend in the outlying user budget class with a message to user 106 that user 106 is over-spending in this budget class, compared to similar individuals. In this way, SO computing device 102 may alert user 106 to what could be a possible reduction in spend even if user 106 over-spends in that budget class, by letting user 106 know that other individuals spend less (i.e., letting user 106 know that it's “possible” to spend less in that budget class).

Some of the plurality of intelligent budgets 230 may include common features, such as a limit on spending in one or more of the same budget classes. However, each intelligent budget 230 is unique from the others and, therefore, presents a different route to satisfying user-defined budget constraint 202. Intelligent budget 230 may include descriptions or other message of the particular ways in which that budget 230 helps user 106 meet their constraint 202. For instance, one budget 230 may include a message to user 106 that indicates a decrease in a “coffee” budget class of 20% (e.g., cutting out a coffee purchase once during a workweek) would help user 106 meet their spending goals.

SO computing device 102 is configured to cause display of set of intelligent budgets 230 on user computing device 104 (e.g., within budgeting platform 110). SO computing device 102 may permit user 106 to see various features of each intelligent budget 230, such as an outcome of following that intelligent budget 230 over a period of time. For example, SO computing device 102 may cause the display to user 106 of the outcome (e.g., spend and/or savings) of following one intelligent budget 230 over six months, or over each month of the six months (e.g., using a slider or via a graph). The display may enable to user 106 to see a detailed breakdown of intelligent budget 230 by time, by budget class, by total outcome, by trending outcome, a level of satisfaction of user-defined budget constraint 202, and/or any other details of intelligent budgets 230. The display may further enable user 106 to rank or sort intelligent budgets 230 by any of these features. For instance, user 106 may be able to select an option that sorts intelligent budgets 230 based on how fast a savings goal is met, or based on the least decrease in spend in one budget class.

Accordingly, SO computing device 102 enables interaction with each intelligent budget 230 such that user 106 may select the particular intelligent budget 232 that best suits the user's needs and/or wishes. SO computing device 102 receives, from user computing device 104, a selection of user-selected intelligent budget 232 from the set of intelligent budgets 230. User-selected intelligent budget 232 forms the basis for active monitoring of the user's real-time or current spending behavior.

In the example embodiment, SO computing device 102 (specifically, a monitoring module 240 thereof) monitors real-time spending behavior 242 of user 106 based upon a plurality of purchase transactions initiated by user 106 after selection of user-selected intelligent budget 232. In the example embodiment, SO computing device 102 is in communication with issuer computing device 112 to monitor such purchase transactions in real-time. Real-time spending behavior 242 is automatically compared to intelligent budget 232. As intelligent budget 232 was generated based upon possible, potential, or theoretical behavior of user 106, there may be differences between the user's actual real-time spending behavior 242 and user-selected intelligent budget 232. Some differences may be “positive,” in that those differences increase the likelihood that user 106, following budget 232 and making real-time spending decisions, will meet budget constraint 202. Other differences may be “negative,” in that those difference decrease the likelihood that user 106, following budget 232 and making real-time spending decisions, will meet budget constraint 202. These “negative” differences may be referred to as “deviations,” and are generally characterized by user 106 over-spending in one or more budget classes and/or over-spending overall. SO computing device 102 may be configured to detect (e.g., in real-time or without substantial delay between deviating behavior and detection) that real-time spending behavior 242 of user 106 deviates from user-selected intelligent budget 232 by a deviation factor 244. SO computing device 102, in response, may generate one or more correction options 246 to compensate for deviation factor 244. Put another way, correction option(s) 246 are generated to put user 106 “back on track” with respect to budget 232 and/or budget constraint 202.

In some embodiments, correction options 246 may be generated as reductions in future spending in the same budget classes in which the over-spending occurred. In other embodiments, correction options 246 may be generated based upon the demographic group budget model and/or correction options generated for other individuals in the same demographic group. For instance, if SO computing device 102 identifies an outlying user budget class for user 106, SO computing device 102 may generate a correction option 246 including a reduction in spend in the outlying user budget class, with or without a message indicating to user 106 that user 106 over-spends in the outlying user budget class compared to other individuals in the demographic group. In other embodiments, correction options 246 may be generated dynamically, based on real-time spending behavior 242 of user 106 (after the selection of user-selected intelligent budget 232) and historical budget model 212. Specifically, in some embodiments, SO computing device 102 is configured to execute a plurality of budget correction simulations 250 based upon historical budget model 212, real-time spending behavior 242, and deviation factor 244. In other words, SO computing device 102 factors in the spending that user 106 has performed since the initial generation and selection of budget 232, and executes new future budget simulations 250, referred to here as “budget correction simulations” 250. SO computing device 102 may then generate the one or more correction options 246 based upon budget correction simulations 250 (and outcomes thereof, not specifically shown, similar to outcomes 222). Each correction option 246 corrects deviation factor 244 such that a combination of user-selected intelligent budget 232, real-time spending behavior 242, and the respective correction option 246 satisfies the at least one user defined budget constraint 202.

User 106 can select SO computing device 102 will handle deviations. User 106 may choose to receive and implement correction options 246, as described above. User may additionally or alternatively request alerts 252 from SO computing device 102. SO computing device 102, in accordance with user preferences, may generate and transmit alerts 252 to user computing device 104 when user 106 overspends in any budget class. User 106 may have preferences for when alerts 252 are to be generated, such as only when user 106 overspends by a threshold amount, when user 106 is about to overspend (e.g., is within a threshold range of a maximum spend of the budget class), and/or under any other conditions. Alerts 252 may cause various outcomes, in accordance with user preferences. Alerts 252 may cause user computing device 104 to activate to alert user 106 to the overspending (e.g., as a push notification or other alert message). Alerts 252 may, additionally or alternatively, cause a spending freeze at merchants or on transactions that would fall within a particular budget class that would result in an over-spend in that budget class. In such cases, SO computing device 102 may communicate with issuer computing device 112 to implement the spending freeze in that budget class. In some embodiments, issuer computing device 112 incorporates messaging to SO computing device 102 into transaction processing, such that SO computing device 102 performs decisioning about whether or not to allow a transaction and/or whether to transmit an alert 252 during processing of a transaction.

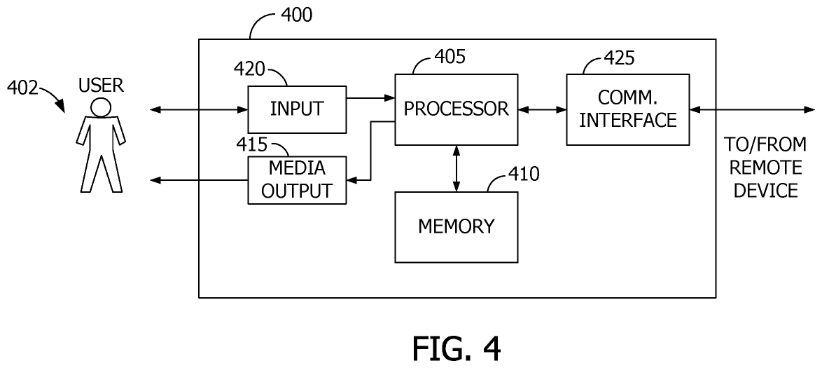

FIG. 4 illustrates an exemplary configuration of a user system 400 operated by a user 402 (who may be the same as user 106, shown in FIG. 1) and that may be used in intelligent budgeting system 100 (shown in FIG. 1). User system 400 may include, but is not limited to, user computer device 104 and/or issuer computing device 112 (both shown in FIG. 1). In the exemplary embodiment, user system 400 includes a processor 405 for executing instructions. In some embodiments, executable instructions are stored in a memory area.

Processor 405 may include one or more processing units, for example, a multi-core configuration. Memory area 410 is any device allowing information such as executable instructions and/or written works to be stored and retrieved. Memory area 410 may include one or more computer readable media.

User system 400 also includes at least one media output component 415 for presenting information to user 402. Media output component 415 is any component capable of conveying information to user 402. In some embodiments, media output component 415 includes an output adapter such as a video adapter and/or an audio adapter. An output adapter is operatively coupled to processor 405 and operatively couplable to an output device such as a display device, a liquid crystal display (LCD), organic light emitting diode (OLED) display, or “electronic ink” display, or an audio output device, a speaker or headphones.

In some embodiments, user system 400 includes an input device 420 for receiving input from user 402. Input device 420 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 415 and input device 420.

Stored in memory area 410 are, for example, computer readable instructions for providing a user interface to user 402 via media output component 415 and, optionally, receiving and processing input from input device 420. A user interface may include, among other possibilities, a web browser and client application. Web browsers enable users, such as user 402, to display and interact with media and other information typically embedded on a web page or a website from a server such as SO computing device 102 (shown in FIG. 1). A client application allows user 402 to interact with a server application.

User system 400 may also include a communication interface 425, which is communicatively couplable to a remote device such as SO computing device 102. Communication interface 425 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

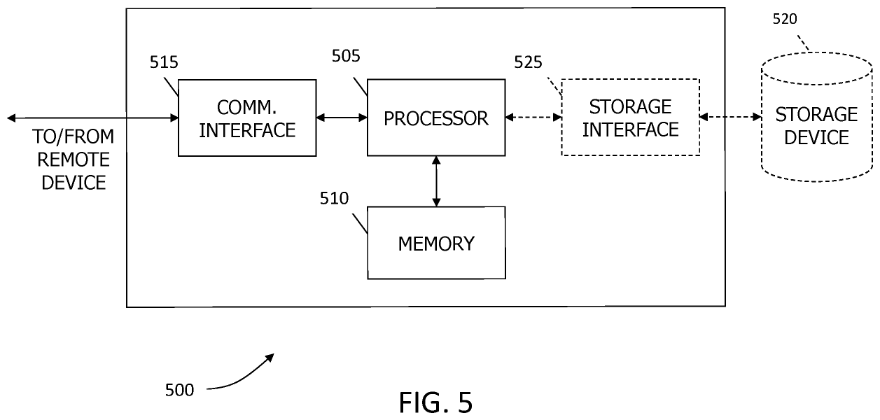

FIG. 5 illustrates an example configuration of a server computing device 500 that may be used in intelligent budgeting system 100 (shown in FIG. 1). Server computing device 500 may include, but is not limited to, SO computing device 102 and/or issuer computing device 112 (both shown in FIG. 1).

Server computing device 500 includes one or more processors 505 for executing instructions. Instructions may be stored in one or more memory devices 510, for example. One or more processors 505 may include one or more processing units (e.g., in a multi-core configuration).

One or more processors 505 are operatively coupled to a communication interface 515 such that server computing device 500 is capable of communicating with a remote device such as user system 400 (shown in FIG. 4). For example, communication interface 515 may receive requests from user computing devices 104 via the Internet or another network, as illustrated in FIG. 1.

One or more processors 505 may also be operatively coupled to one or more storage devices 520. One or more storage devices 520 are any computer-operated hardware suitable for storing and/or retrieving data. In some embodiments, one or more storage devices 520 are integrated in server computing device 500. For example, server computing device 500 may include one or more hard disk drives as one or more storage devices 520. In other embodiments, one or more storage devices 520 are external to server computing device 500 and may be accessed by a plurality of server computing devices 500. For example, one or more storage devices 520 may include multiple storage units such as hard disks or solid state disks in a redundant array of inexpensive disks (RAID) configuration. One or more storage devices 520 may include a storage area network (SAN) and/or a network attached storage (NAS) system. In some embodiments, one or more storage devices 520 may include database(s) 108 (shown in FIG. 1).

In some embodiments, one or more processors 505 are operatively coupled to one or more storage devices 520 via a storage interface 525. Storage interface 525 is any component capable of providing one or more processors 505 with access to one or more storage devices 520. Storage interface 525 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 505 with access to one or more storage devices 520.

One or more memory devices 410 and 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

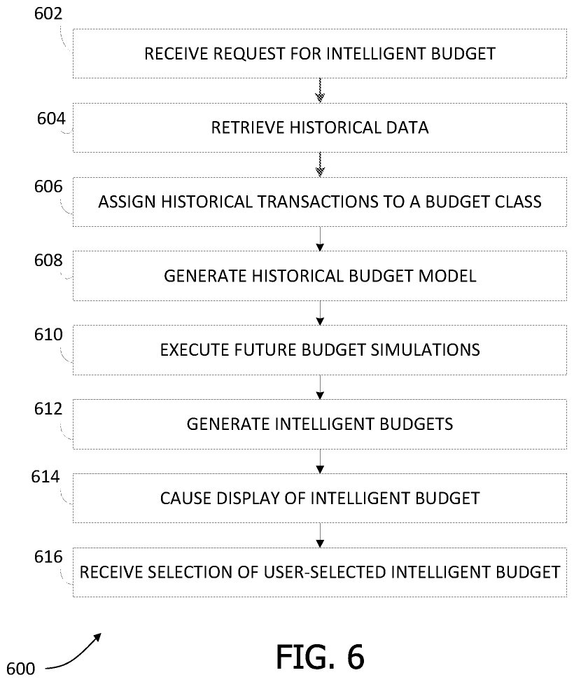

FIG. 6 is a flowchart of an example method 600 of using simulations to generate an intelligent budget, using intelligent budgeting system 100 shown in FIG. 1. In the example embodiment, method 600 is performed by simulation and optimization (SO) computing device 102 (shown in FIG. 1).

In the example embodiment, method 600 includes receiving 602 a request for an intelligent budget from a user (e.g., user 106, shown in FIG. 1), wherein the request includes at least one user-defined budget constraint (e.g., user-defined budget constraint 202, shown in FIG. 2). Method 600 also includes retrieving 604, from a first database (e.g., historical purchase transaction database 108A, shown in FIG. 1), historical data (e.g., historical data 210, shown in FIG. 2) associated with a plurality of historical purchase transactions initiated by the user over a period of time.

In addition, method 600 includes assigning 606 each historical purchase transaction of the plurality of historical purchase transactions one budget class of a plurality of budget classes, and generating 608 a historical budget model (e.g., historical budget model 212, shown in FIG. 2) based upon the plurality of historical purchase transactions and the plurality of budget classes. The historical budget model represents historical spending behavior of the user over the period of time.

Method 600 further includes executing 610 a plurality of future budget simulations (e.g., simulations 220, shown in FIG. 2) based upon the historical budget model, each future budget simulation of the plurality of future budget simulations identifying a possible future spending behavior of the user. Method 600 also includes generating 612 a plurality of intelligent budgets (e.g., intelligent budgets 230, also shown in FIG. 2) based upon the plurality of future budget simulations. Each intelligent budget of the set of intelligent budgets is generated based upon a respective possible future spending behavior that satisfies the at least one user defined budget constraint.

Method 600 also includes causing display 614, on a user computing device of the user, of the set of intelligent budgets, and receiving 616, from the user computing device, a selection of a user-selected intelligent budget (e.g., user-selected intelligent budget 232, shown in FIG. 2) from the set of intelligent budgets. Method 600 may include fewer, additional, and/or alternative steps, including those described elsewhere herein.

As will be appreciated based on the foregoing specification, the above-described embodiments of the disclosure may be implemented using computer programming or engineering techniques including computer software, firmware, hardware or any combination or subset thereof, wherein the technical effect of the systems and processes described herein is achieved by creating a network-based system for generating a budget for an individual. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A simulation and optimization (SO) computing device for generating intelligent budgets, the SO computing device comprising one or more processors in communication with one or more memory devices, said SO computing device configured to:
receive a request for an intelligent budget from a user operating a user computing device, wherein the request includes at least one user-defined budget constraint;
retrieve, from a first database, historical data associated with a plurality of historical purchase transactions initiated by the user over a period of time;
assign each historical purchase transaction of the plurality of historical purchase transactions one budget class of a plurality of budget classes;
generate a historical budget model based upon the plurality of historical purchase transactions and the plurality of budget classes, the historical budget model representing historical spending behavior of the user over the period of time;
execute a plurality of future budget simulations based upon the historical budget model, each future budget simulation of the plurality of future budget simulations identifying a possible future spending behavior of the user;
generate a plurality of intelligent budgets based upon the plurality of future budget simulations, wherein each intelligent budget of the plurality of intelligent budgets is generated based upon a respective possible future spending behavior that satisfies the at least one user-defined budget constraint;
cause to be displayed, on the user computing device, the plurality of intelligent budgets; and
receive, from the user computing device, a selection of a user-selected intelligent budget from the plurality of intelligent budgets.

2. The SO computing device of claim 1 further configured to generate the historical budget model to include an assigned probability distribution for each budget class, wherein each probability distribution indicates a probability of the user spending a particular amount within a range of amounts on purchase transactions assigned to one budget class of the plurality of budget classes.

3. The SO computing device of claim 2, wherein to execute the plurality of future budget simulations, the SO computing device is further configured to:
execute a Monte Carlo iteration for each of the plurality of future budget simulations using the assigned probability distributions for each budget class of the plurality of budget classes; and
record an outcome of each Monte Carlo iteration, wherein the outcome identifies the possible future spending behavior of the user associated with the respective Monte Carlo iteration; and
wherein the SO computing device is further configured to:
compare the outcome of each Monte Carlo iteration to the user-defined budget constraint; and
isolate the outcomes that satisfy the user-defined budget constraint from the outcomes that do not satisfy the user-defined budget constraint.

4. The SO computing device of claim 3, wherein to generate the plurality of intelligent budgets, the SO computing device is further configured to:
identify a plurality of subsets of the outcomes that satisfy the user-defined budget constraint, wherein each subset includes outcomes having one or more common factors; and
generate a corresponding intelligent budget of the plurality of intelligent budgets that includes the one or more common factors.

5. The SO computing device of claim 1 further configured to:
monitor real-time spending behavior of the user based upon a plurality of purchase transactions initiated by the user after selection of the user-selected intelligent budget;
detect that the real-time spending behavior of the user deviates from the user-selected intelligent budget by a deviation factor; and
generate one or more correction options to compensate for the deviation from the user-selected intelligent budget.

6. The SO computing device of claim 5 further configured to:
execute a plurality of budget correction simulations based upon the historical budget model, the real-time spending behavior, and the deviation factor; and
generate the one or more correction options based upon the plurality of budget correction simulations, wherein each correction option of the one or more correction options corrects the deviation factor such that a combination of the user-selected intelligent budget, the real-time spending behavior, and the respective correction option satisfies the at least one user-defined budget constraint.

7. The SO computing device of claim 1 further configured to:
determine, based on the historical data associated with the plurality of historical purchase transactions, that an amount spent by the user in a first budget class of the plurality of budget classes is substantially fixed;
flag the first budget class as a fixed budget class; and
exclude the fixed budget class from varying in the plurality of future budget simulations.

8. A computer-implemented method for generating intelligent budgets, implemented using a simulation and optimization (SO) computing device including one or more processors in communication with one or more memory devices, said method comprising:
receiving a request for an intelligent budget from a user operating a user computing device, wherein the request includes at least one user-defined budget constraint;
retrieving, from a first database, historical data associated with a plurality of historical purchase transactions initiated by the user over a period of time;
assigning each historical purchase transaction of the plurality of historical purchase transactions one budget class of a plurality of budget classes;
generating a historical budget model based upon the plurality of historical purchase transactions and the plurality of budget classes, the historical budget model representing historical spending behavior of the user over the period of time;
executing a plurality of future budget simulations based upon the historical budget model, each future budget simulation of the plurality of future budget simulations identifying a possible future spending behavior of the user;
generating a plurality of intelligent budgets based upon the plurality of future budget simulations, wherein each intelligent budget of the plurality of intelligent budgets is generated based upon a respective possible future spending behavior that satisfies the at least one user-defined budget constraint;
causing to be displayed, on the user computing device, the plurality of intelligent budgets; and
receiving, from the user computing device, a selection of a user-selected intelligent budget from the plurality of intelligent budgets.

9. The method of claim 8, wherein generating a historical budget model comprises generating the historical budget model to include an assigned probability distribution for each budget class, wherein each probability distribution indicates a probability of the user spending a particular amount within a range of amounts on purchase transactions assigned to one budget class of the plurality of budget classes.

10. The method of claim 9, wherein executing the plurality of future budget simulations comprises:
executing a Monte Carlo iteration for each of the plurality of future budget simulations using the assigned probability distributions for each budget class of the plurality of budget classes; and
recording an outcome of each Monte Carlo iteration, wherein the outcome identifies the possible future spending behavior of the user associated with the respective Monte Carlo iteration; and
said method further comprising:
comparing the outcome of each Monte Carlo iteration to the user-defined budget constraint; and
isolating the outcomes that satisfy the user-defined budget constraint from the outcomes that do not satisfy the user-defined budget constraint.

11. The method of claim 10, wherein generating the plurality of intelligent budgets comprises:
identifying a plurality of subsets of the outcomes that satisfy the user-defined budget constraint, wherein each subset includes outcomes having one or more common factors; and
generating a corresponding intelligent budget of the plurality of intelligent budgets that includes the one or more common factors.

12. The method of claim 8 further comprising:
monitoring real-time spending behavior of the user based upon a plurality of purchase transactions initiated by the user after selection of the user-selected intelligent budget;
detecting that the real-time spending behavior of the user deviates from the user-selected intelligent budget by a deviation factor; and
generating one or more correction options to compensate for the deviation from the user-selected intelligent budget.

13. The method of claim 12 further comprising:
executing a plurality of budget correction simulations based upon the historical budget model, the real-time spending behavior, and the deviation factor; and
generating the one or more correction options based upon the plurality of budget correction simulations, wherein each correction option of the one or more correction options corrects the deviation factor such that a combination of the user-selected intelligent budget, the real-time spending behavior, and the respective correction option satisfies the at least one user-defined budget constraint.

14. The method of claim 8 further comprising:
determining, based on the historical data associated with the plurality of historical purchase transactions, that an amount spent by the user in a first budget class of the plurality of budget classes is substantially fixed;
flagging the first budget class as a fixed budget class; and
excluding the fixed budget class from varying in the plurality of future budget simulations.

15. A non-transitory computer readable storage medium that includes computer executable instructions for generating an intelligent budget, wherein when executed by a simulation and optimization (SO) computing device comprising a processor in communication with a memory device, the computer executable instructions cause the SO computing device to:
receive a request for an intelligent budget from a user operating a user computing device, wherein the request includes at least one user-defined budget constraint;
retrieve, from a first database, historical data associated with a plurality of historical purchase transactions initiated by the user over a period of time;
assign each historical purchase transaction of the plurality of historical purchase transactions one budget class of a plurality of budget classes;
generate a historical budget model based upon the plurality of historical purchase transactions and the plurality of budget classes, the historical budget model representing historical spending behavior of the user over the period of time;
execute a plurality of future budget simulations based upon the historical budget model, each future budget simulation of the plurality of future budget simulations identifying a possible future spending behavior of the user;
generate a plurality of intelligent budgets based upon the plurality of future budget simulations, wherein each intelligent budget of the plurality of intelligent budgets is generated based upon a respective possible future spending behavior that satisfies the at least one user-defined budget constraint;
cause to be displayed, on the user computing device, the plurality of intelligent budgets; and
receive, from the user computing device, a selection of a user-selected intelligent budget from the plurality of intelligent budgets.

16. A non-transitory computer readable storage medium in accordance with claim 15, wherein the computer-executable instructions further cause the SO computing device to generate the historical budget model to include an assigned probability distribution for each budget class, wherein each probability distribution indicates a probability of the user spending a particular amount within a range of amounts on purchase transactions assigned to one budget class of the plurality of budget classes.

17. A non-transitory computer readable storage medium in accordance with claim 16, wherein to execute the plurality of future budget simulations, the computer-executable instructions further cause the SO computing device to:
execute a Monte Carlo iteration for each of the plurality of future budget simulations using the assigned probability distributions for each budget class of the plurality of budget classes; and
record an outcome of each Monte Carlo iteration, wherein the outcome identifies the possible future spending behavior of the user associated with the respective Monte Carlo iteration; and
wherein the computer-executable instructions further cause the SO computing device to:
compare the outcome of each Monte Carlo iteration to the user-defined budget constraint; and
isolate the outcomes that satisfy the user-defined budget constraint from the outcomes that do not satisfy the user-defined budget constraint.

18. A non-transitory computer readable storage medium in accordance with claim 17, wherein to generate the plurality of intelligent budgets, the computer-executable instructions further cause the SO computing device to:
identify a plurality of subsets of the outcomes that satisfy the user-defined budget constraint, wherein each subset includes outcomes having one or more common factors; and
generate a corresponding intelligent budget of the plurality of intelligent budgets that includes the one or more common factors.

19. A non-transitory computer readable storage medium in accordance with claim 15, wherein the computer-executable instructions further cause the SO computing device to:
monitor real-time spending behavior of the user based upon a plurality of purchase transactions initiated by the user after selection of the user-selected intelligent budget;
detect that the real-time spending behavior of the user deviates from the user-selected intelligent budget by a deviation factor; and
generate one or more correction options to compensate for the deviation from the user-selected intelligent budget.

20. A non-transitory computer readable storage medium in accordance with claim 19, wherein the computer-executable instructions further cause the SO computing device to:
execute a plurality of budget correction simulations based upon the historical budget model, the real-time spending behavior, and the deviation factor; and
generate the one or more correction options based upon the plurality of budget correction simulations, wherein each correction option of the one or more correction options corrects the deviation factor such that a combination of the user-selected intelligent budget, the real-time spending behavior, and the respective correction option satisfies the at least one user-defined budget constraint.
